(19) United States
(12) Patent Application Publication
(10) Pub. No.: US 2003/0101950 A1
(43) Pub. Date: Jun. 5, 2003

(54) Exhaust valve and intake system

(76) Inventor: Cesare Bortone, Lecce (IT)

Correspondence Address: BIRCH STEWART KOLASCH & BIRCH, PO BOX 747, FALLS CHURCH, VA, 22040-0747, US

(21) Appl. No.: 10/182,378

(22) PCT Filed: Jun. 28, 2001
(86) PCT No.: PCT/IT01/00343

(30) Foreign Application Priority Data
Jun. 29, 2000 (IT) LE2000A000014

(51) Int. Cl. F02B 75/18

(52) U.S. Cl. 123/90.15; 123/56.3

(57) ABSTRACT

N.E.V.I.S. stays for New Exhaust Valve and Intake System. This invention defines together with a new charge regulating system and a special valve for the function of the exhaust, several innovative elements that change completely the traditional alternative engine. Thanks to this new concepts, efficiency can be drastically improved, wile the dimensions, the weight and the power are comparable to wankel or to gasturbine and the expectations of the emissions and production cost are very interesting, wile the radically new architecture of the block allows to have the advantages of a complete modularity of the cylinders (every block can be associated to another one), the pistons are annular and are provided in the lower part of ball bearing that follow a convenient law of the movement caused by a cylinder surrounded by an undulated slot where the ball bearings are operatively inserted. The exhaust is timed and variable like the compression ratio; the cleaning phase happens via the inertia of the fluids in a vast rang of revolutions per minute, differently from Kadenacy system. The lubrication system is of the spraying kind, the cooling system is with circulation of liquid, the injection is direct for both the versions diesel or gasoline one. A transmission shaft can be inserted in the engine shaft, permitting to the engine an axial positioning between two tires, if the number of cylinders adopted is not excessive. It is possible to put on the same axis two, three, four or six cylinders, one after the other one, without having problems of balancing; the number of maximum revolutions per minute is very low so to have a correct ratio with a propeller or an eventual tire it isn't neede any reducing gear between the transmission and the differential, because the number of cycles are three in one engine shaft revolution instead of half.

### BACKGROUND ART

Only four types of engines have been applied on large scale in the history of engines, substantially:

The four stroke engine.

The two stroke engine.

The Wankel engine.

The gas turbine.

It is worth to mention some engines like the electric one, the steam one, the Stirling and the fuel-cells, but the actual level of their development does not allow them to compete with the internal combustion engines, because of their excessive production costs or for their inefficiency or low functionality.

In the seventies the gas turbine, seemed able to replace, in automotive applications, the classic four stroke, owing to it's simplicity and it's truly narrow dimensions; besides, in aeronautical field, this engine has proved to have a better efficiency than the alternative one: it had no vibrations, it was clean, it was longly durable and powerful. On the other hand, the acceptable efficiency could be reached only with very hi temperatures in the combustion chamber, so it was necessary to build the turbine with special materials, too expensive for a large production.

Not even the Wankel has been capable to replace the four stroke alternative engine, even though it had almost similar prerogatives to the turbine but not the prohibitive costs of it. Even in this case the chronic hi consumption united to a reliability that was possible to render acceptable only recently, have invalidate the complete success of it, it is used anyhow, in those applications in witch the consumption is a secondary parameter.

The two stroke, on the contrary, if until few years ago had a plurality of bad defects, (the consumption, the excessive emissions, the irregular functioning at low r.p.m), with the last evolutions, shows highly respectable efficiency and functionality, his dimensions that are almost half for the same power, have motivated a new start of its development that rendered the engine better than the four stroke.

Particularly, the two stroke diesel with the controllable opening of the exhaust system, or the hybrid applications, an electric engine coadjuted from a small alternative internal combustion engine, (that works constantly at the maximum couple r.p.m.), are able to have good efficiency. These last ones although, are more expensive, due to the adding costs of the electric engine.

It is obvious that to obtain substantial evolution from an engine it is necessary to operate on various directions:

Reduction of more possible looses from the exhaust, and the wastes of the irradiation, because the thermical rendering of alternative endothermic engines is very modest.

Efficiency improvement at all r.p.m. And at all the requests of charges (at the maximum couple r.p.m, the internal friction of engines allows renderings of 08, but at moderate charges and r.p.m. only a modest 0.55 of efficiency can be achieved; this fact assumes huge importance, if it is considered that in a car the life of the engine is for the 80% engaged at the partial charges and low r.p.m.)

Correct combustion in order to obtain benefits not only in terms of consumption and performances, but also for a reduction of emissions.

Increase of engine versatility, the optimum would be to have the possibility to use the propulsor in different sectors, in the aeronautical ones in the automotive one, nautical, etc.

Foresee a drawing with the total modularity of the block and of the heads, in order to have ample choice of power

Simplicity of the engine, that has no needs of complex or expensive working process nor precious materials.

Easy maintenance, assembling and disassembling.

An architecture drawing of the engine light and compact.

All these aspects have been contemplated in inventing this new engine.

The combination of some ideas, right after exposed, make possible to realize a new architecture that allows to concentrate in the engine all the prerogatives and the improvements cited before, in a simple and compact structure, included in a block substantially cylindrical:

1) The first idea utilized was thought and experimented from the tecnic Kadenacy and it is a method capable of obtaining the cleaning phase of the two stroke engine that takes advantage of the inertia of the air that is in the duct of the intake and that is recalled by the depression existing in the combustion chamber immediately after the moment of the exit of the exhaust gases; this method gives considerable advantages in term of efficiency and relieves the obligations to use turbines or compressors of various types generally used for the cleaning.

2) The second idea helps to solve the serious limitations of Kadenacy method that works only in a very small range of r.p.m Of the engine. It consists in adopting a controlled annular exhaust valve, ample and with adjustable times of the lift as it is needed, in both cases of the beginning and of the duration of the lift; this enables, at the end of the cleaning phase, to regulate the quantity of air that must be kept in the combustion chamber for the following combustion. Differently from what happens with the partializations realised by the throttle in the duct of the intake, the air is free to enter copiously in the combustion chamber. but without all the excess, in order to effectuate an optimal cleaning with all the charges and all the rotation regimes.

3) The third characterisation is the adoption of a special shaft for the transformation of the alternate rectilineous movement of the pistons, in rotating and that reminds the sinusoidal camshaft adopted in the engines that had the cylinders arranged coaxial around the shaft, the new special shaft although differs for many aspects that concern.

a—The relievement of the structures of the parts that are in alternative movement.

b—The possibility to regulate through an element of the shaft, the variation of compression ratio at all rotating regimes and at all charges.

c—The different planning of the lows of the alternative movement of the piston suggested by Prof. D. Laforgia and Prof. M Candeo,. that carries out significative advantages like the reduction of the maximum and mean time velocities of the piston (obtained thanks to the constant accelerations and decelerations of the pistons, that can, in addition, stop for a while to the top dead points for better ultimating cleaning phase and combustion).

d—The possibility to complete in only one revolution of the shaft three operatives' combustion cycles.

4) The adoption of annular pistons completes and facilitates in a new and more rational way the advantages until now listed with a strong, light and multifunctional structure, useful for the spark ignited combustion and for the combustion caused from compression.

### DISCLOSURE OF INVENTION

It is necessary to underline that all the ideas or solutions mentioned are co-operatively functional and that the missing of only one of them invalidates much of the efficiency and the prerogatives of the engine. Particular attention has been used in choosing and adopting already tested mechanical solutions (with the exception of an internal segments of the piston and a segment for the ermetization of the valve), in order to have no surprises during the experimental setting phases of a prototype. A direct injection is, naturally the more suitable to render correct and possible the integration of all the ideas exposed.

The difficulty, never surmounted, of the direct injection of gasoline in the “two stroke”, consists in the insufficient vaporization of gasoline. Differently from the gasohol that can be burned in very small drops, the gasoline must be transformed in vapour, otherwise it doesn't burn correctly. This vaporization needs a certain amount of time and a subministration of beat. For what concerns the heat the direct injection in the combustion chamber offers a surely hotter ambient than the duct of the intake. For what about the amount of time needed to vaporize, that is not sufficient (in the traditional “two stroke” there are 100° degrees of revolution available, that means about 2 millesimal of a second at 7500 r.p.m.), some realizations apply the solution to premix with compressed air the gasoline, or utilize higher pressure of the injection, to obtain a better pulverization of gasoline.

In this engine the amount of time useful for the vaporization is almost 2.5 times longer, as it is easy to deduce from the diagram of the timing system, FIG. (11) that gives disposal of an arc of 240° degrees to be used starting from the closing of the exhaust and 20° degrees after the top dead point before the spark fires.

The fundamental aspects that are at the base of the prerogatives and of the modus operandi of the new engine can be cleared also by what follows.

The principal reasons that do not allow the normal “two stroke” to activate a high midpressure, if compared to the “four stroke” engine, is due to the following factors.

1) The fulfilling is highly invalidated from the dimensions of the holes of the intake, necessarily small because there is the need of sufficient lateral space for the holes of the exhaust that must avoid the vertical extension mortifying excessively the exploitation of the expansion (in “four stroke” the valves are very large).

2) The cleaning phase is not correct at all regimes of revolution and to all charges, because of the parzialization made from the duct of the intake. So it happens always to have part of the. exhaust residues in the combustion chamber that cause an amount of problems to the oxidation (this happens in smaller proportion in the “four stroke”).

3) Looses of gasoline from the exhaust for the impossibility to effectuate the injection after the closure of the exhaust holes, unless the direct injection is utilised, that for using high pressures and expensive devices that anyhow can help little at high rotation regimes, considering the reduced time remaining for the vaporisation of the gasoline (the “four stroke” on the contrary has a lot of useful time to effectuate the vaporisation even with the direct injection)

4) Reduction of the exploitation of a part of expansion because of the anticipated opening of the exhaust hole that is settled in a high position on the cylinder, in correspondence of which the piston receives still a strong pressure and the connecting rod pushes on a crank of the shaft that generally has a position of 70° as regards the inferior dead point and “pushes” still in an efficacious way. In a “four stroke” the proportion of this problem is less heavy, thanks to the delay of the opening of the values that begins at about 60° of angle of crank of the shaft as respect to the inferior dead point; it's like having in the “two stroke” about 15% of useful stroke missing, if compared with a “four stroke” of the same displacement.

All these negative aspects of the traditional “two stroke” are solved by the engine that is here disclosed coherently with a preferred form of realization that from now on will be called N.E.V.I.S. to simplify:

1) In N.E.V.I.S. the holes for the intake and for the exhaust are of a much bigger proportion than the ones in the classic “two stroke” and they are the double of the “four stroke”, also the flow coefficient is considerably higher; so there are no problems under this aspect for the fulfilling.

2) The cleaning of N.E.V.I.S. differently from the traditional “two stroke” can be complete and very clean and also very easy to regulate at all r.p.m. And at all charges for an optimal expulsion of all the residues of the combustion maybe even better than the “four stroke” specially at partial charges, thanks to the variable lifting law of the exhaust valve and thanks to their regulating timing system. In the “two stroke” this problem assumes unacceptable proportion.

3) The N.E.V.I.S. has time for the vaporization 2,4 times longer than the normal “two stroke”.

4) Considering the relative highness of the intake holes and considering that the opening of the exhaust, compared with a normal crankshaft, begins at 55° degrees of angle of crank with respect to the inferior dead point, there are no looses of pressure at the end of the stroke like in the classic two stroke and it is possible to do better than the “four stroke”. But the most important advantage for N.E.V.I.S. is surely the reduction of looses of work for the cleaning phase considering that are used energies destined to be lost from the exhaust.

This can't be done neither from the “two strokes” neither from the “four stroke” that on the contrary need to spend a big amount of energies to pump away the residues of the combustion (one for the pump action one for the two added strokes).

For all this reasons it should be clear that it is an error to consider the single cycle of the “four stroke” two times more efficacious than a single cycle of N.E.V.I.S., like it generally happened when the normal two stroke is compared to the “four stroke”.

In only one cycle N.E.V.I.S. can give a mid pressure highly superior to the single cycle of the “two stroke” and only pessimistically equal to the “four stroke” cycle, while at partial charges and low r.p.m. Not even the four strokes are capable of sustaining the comparison, standing the fact that the compression ratio can not be modified during the operative cycle.

As a matter of facts N.E.V.I.S. is a two stroke that repeats the cycle three times in one revolution of the shaft, as it's known the “four stroke” completes an entire cycle in two revolutions of the crankshaft, so a correct confront could be to compare to N.E.V.I.S. a “four stroke” which revolutions are six times faster, if truly the comparison desired is between two monocilindrics, even though a more rational comparison is with a three cylinder that has double r.p.m. And a unitary displacement that is equal to the single piston of N.E.V.I.S., being obvious that a revolution six times faster would cause excessive mid velocity of the four-stroke piston. Anyhow the comparison between monocilindrics can offer a clear and even more evident demonstration of the superiority of N.E.V.I.S.

For example, about the important parameter of the times needed for the vaporisation, and assuming a proved data of the times of vaporisation of the actual “four stroke”, that means 8 mm of second at 6000 r.p.m. (300° degrees of engine shaft revolution) surely more than the 5 millesimums of second that are at N.E.V.I.S. disposal at maximum r.p.m., that means at 2000 r.p.m., but for what said before, having N.E.V.I.S. at 2000 r.p.m., the double of cycles of the “four stroke” that turns at 6000 r.p.m., it is necessary to double the turns of the “four stroke” to have a correct condition of comparison between monocilindrics, in this case the “four stroke” would have only 4 millesimum of second of time to vaporise, and that is the 20% less than N.E.V.I.S., that probably becomes the 40% if the calculus or the experimentation on the banch of the new “two stroke”, will foresee the effective shift of the fuel and of the motion of the charge in the combustion chamber, exactly like the “four stroke” takes advantage of this, will make possible to anticipate of a percentage of time that will be approximately at a 20% of degrees more, this if the comparison is with the monocilindric whose revolutions is six time faster, but let's examine what is obtainable if the comparison is more reasonably between a “four stroke” three cylinder of the same unitary displacement whose revolutions are only doubled:

For what exposed before the useful time for the vaporization in the “four stoke” should be almost two times superior, but in this case the difference is given by the enormous friction and the dispersion of heat on the vast surfaces of a three cylinder that has much more importance of the vaporization times if the engine efficiency is the principal aim and if the rotation of N.E.V.I.S. Are around 2000 r.p.m, as needed for a normal propeller, there is no need to have longer times of vaporization than N.E.V.I.S. possibility (in formula 1 has been cleared that with direct injection 4 millesimum of second are more than sufficient to vaporize), anyhow because of the adoption of three injectors with only 50 bar of pressure in order to better atomise and to reduce conspicuously the time needed for the vaporisation and considering that the injection happens prominently during the moments in witch the pressure in the cylinder is inferior or equal to the atmospheric and the velocity of the air is considerable, due to the swirl caused from deflectors, that are all around the fessure of the intake, the velocity of vaporization and of the drops increases and it should not be forget that the combustions happens in a constant volume and in an optimal pressure due to the stops of the pistons at the dead points, all this facts are positive also for the difficult vaporisation of those cases in witch at high r.p.m. Corresponds very small charges, in fact if on one side the delay of the opening of the injectors (that should not inject if the exhaust is open) absorbs time at the vaporisation on the other side the variable compression ratio is of a bigger help and results more useful than other devices because the very close positioning of the piston towards the head of the engine, causes a strong squish effect together with a concentration of all the charge towards the space under the spark plug, reducing drastically the space that the flame front has to cover in the time necessary for a complete oxidation, that now needs less time, that for can start later, giving back time to the vaporisation of the charge, that being minimal at low charges has reduced injection times and this allows another adding small amount of time for vaporisation.

About the movement of the charge in the combustion chamber, swirl, squish, tumble, and also the relative intensity of the injection, these are things that normal engine also have, but it was correct to underline that also in the new “two stroke” is possible to have this positive aspects like in the traditional engines and that not a single aspect has been neglected while inventing this engine, indeed the many possible drawings of the head of the engine and of the top of the piston give more chances to this engine than to the traditional “four stroke”, that is limited by the cavities for the opened valve, the irregular band of squish and the absence of symmetrical flow from intake also typical in the “two stroke”, for all this they are potentially less optimizable under this aspects.

In the new engine it is possible to regulate, as explained, in a continuous manner and in all range of functioning, the depression of the exhaust thanks to which the cleaning phase can bee done, this depression is much more important then the depression that is present in the combustion chamber of a “four stroke”, during the crossed openings of both the intake and the exhaust, the air is called in the combustion chamber more quickly and there are no risks of an exaggerated slowdown of the air coming in, so that in all using conditions it is possible to have useful velocity of the air for the fulfilling and for the conservation of a good amount of kinetic energy, that sustain the movements of the charge (swirl,squish and tumble), that are so useful for a correct and fast combustion.

The fact that the piston has a very limited mid velocity, must not give the wrong idea of a slowdown of the movements of the charge, in fact the time used from the piston to compress the charge is not longer than the one of the compared “four stroke”, as a matter of fact the piston moves the same quantity of charge in the same time and in the same volume or even smaller.

Also the combustion, happens in the same amount of time or even less than in the “four stroke” and happens in a volume much smaller and constant like sabathe cycle determines, in a condition, so in which the front of the flame does not find variation of pressure and a more uniformed temperature together with a turbulence, caused from the squish, always present at all charges and at all range of r.p.m. thanks to the variation of the compression ratio that makes closer or farer the squish band from the head like it is needed.

In all engines exactly during the combustion which is the most hot phase, happens in proportion the biggest transfer of heat to the walls of the cylinders, in the new propulsor the midvolume smaller in this phase, is added to the utility of being able to reduce more at partial charges the volume of the chamber thanks to the variable compression ratio, and considering that for a good part of the life of an engine partial charged are used, reducing the volume of the chamber more than the surface/volume ratio, during these phases results more important not only to reduce the looses of heat from the walls (that become less ample), but also to obtain a good mid pressure.

It is not correct to think that the piston creates during his stop at top dead point. that this advantage of a bigger loose of beat, because the time of the combustion or the velocity of the front flame do not grow up, so we do not have a long time of dispersion of heat. but simply a smaller volume of the combustion chamber during all the combustion. The more uniform temperature in the combustion chamber allows anyhow the adoption of compression ratio medially higher at all r.p.m. And at all charges, this for the ulterior advantage of the entire volume and of the walls interested from the dispersion of heat; also during the phase of expansion that it lasts for shorter time than the phase of expansion of the traditional engines (that for the constant acceleration of the piston in N.E.V.I.S.), we loose obviously less heat

It can seen like that short one stoke like N.E.V.I.S. one is not worth to obtain optimal results in terms of consumption, in fact generally he most the parsimonious engines (and also with less specific power) have generally strokes particularly long, but the reason why such a short stroke has been adopted, is not due only to the need to have freedom of a high specific power, but also to a multitude of factors that give the possibility anyhow to reduce consistently also the consules, combining also prerogatives of reduced alternative forces and more compact dimensions of the engine.

In fact the traditional engines with relative long stroke permit if a cylinder displacement and a number of them is equal to have some advantages essentially from a thermic point of view, like the concentrate form and so a high rendering of the combustion chamber, but this is a small thing if compared with what N.E.V.I.S. can do and for what before exposed about thermic dispersion and for the volume in which the combustion happens, but also for the more favourable surface/volume/ratio of the combustion chamber even in the phase of maximum expansion that still maintaining a high functionality for the cooling (as better cleared after) it offers an inferior dispersion from the whole of the chamber in comparison to a classic three cylinder four stroke hat for equity should be compared if reasonably the mid velocity of the traditional pistons are sufficiently low and that naturally are exposed to the cooling, together with cylinders, for a time that is at every cycle doubled in comparison to N.E.V.I.S. (the four stoke has looses in the four stroke too).

Why in the N.E.V.I.S. as said before, the cooling is more efficient standing the reduced dispersion of the heat? The reason is as simple as intuitive:

If you try to cool down the centre of a piston you must absorb a great amount of heat from the periferic part of the piston until you obtain progressively the temperature desired at the centre of the piston, but at that point the periferic parts will be at a temperature much lower than the one in the centre and this against the fact that the periferic structure is much stronger than the centre of the piston, you have, in other words, an excessive heat absorbing in the periferic part to maintain cool the centre of the piston. This does not happen with the toroidal piston because the centre of the piston is directly cooled. like the periphery, from the cooling liquid, so the heat absorbed in the periphery can be calibrated without exidings standing the absence of a centre, and without having the risk to find some points hotter because of the interference with other structures or with other cylinders that in normal engine are one between the other while in N.E.V.I.S. they are axially one the other and well separated.

It is now necessary to spend some words about HC at the exhaust, indubitably one of the causes of the presence of HC is caused from the unoxidated part of charge that is in the thin part right up the first segment (crevices) and in the toroidal this thin part is much more extended than in the common cylinder, but as already said it is only one of the causes, that must be added to other ones that in the described engine are less influent in comparison with normal engines and probably give substantial reductions not increments of hc Infact in the traditional two stroke engine, the concentration of HC rice particularly high levels because the mix of air and gasoline highly rich during the washing phase is mixed in the combustion chamber with the residues of burned gases and with this part of the gasoline comes out from the cylinder without burning; in the new engine this does not happen because during the washing phase there is still no gasoline in the chamber and at the and of the washing phase only clean air remains that can be mixed with the injected gasoline in a correct sthechiometric and compression ratio and nothing can escape from the chamber because the exhaust is closed.

In the normal four stroke, on the contrary, even though there are not so ingent looses from the exhaust (unless you have strong crosses between the opening of the intake and of the exhaust) the concentration of hc reaches particularly high levels when the engine works with strong depression in the intake duct (that happens at minimum r.p.m. and during the deceleration) because the fuel is very rich of gasoline the expulsion of the burned gases is even less complete and the compression ratio is very low.

In the other condition of functioning the presence of hc in the exhaust gas is due to an incomplete combustion of the fuel in the substrate attached to the walls of the combustion chamber at a lower temperature than the one in which the reaction of oxidation can happen; this is a function of the mid temperature in the combustion chamber that has said before, talking about surface/volume ratio, in the new engine it is uniform and more elevated, particularly around the exhaust valve, that represents one of the walls of the crevices upon the first segment before mentioned, the wall is not surrounded externally from the cooling liquid, that is why there are less heat looses from the chamber and so to reduce the substratum before mentioned.

Ultimately there are many possible solutions to eliminate further the hc, thermical reactors and various catalytic can help, but what is truly useful is the consistent reduction of the problem at his origin, and that means a correct and complete combustion in all the range of function; the prerogatives of the new engine, thanks to all the possible regulations make this concretely actual, and taking the suggestion from the studies developed from the famous Austrian company of research and development AVL, in terms of emissions close to 0, interesting prospective are suggested in this field, being possible for the engine the hybrid functioning with accention by compression but with injection of gasoline and not gasohol, this can be obtained thanks to the variable compression ratio that permits to control the high peaks of excessive pressure.

This is with all probability, the way for the future to obtain very low emissions and this is even more important if it is considered the urgent necessity to give adequate answers to the impositions of the new and severe laws of the immediate future.

The versatility of the engine offers the opportunity to easy interest to many sectors together with the aeronautical one.

This is an important evolution that gives further guarantees for the commercial success.

It doe not exist in fact any previous historical example of complete modularity that includes also the block so you are free to add as many units you like, ranging, in this way, from minimum displacements and powers to big horse power, maintaining unchanged all the prerogatives of efficiency, durability, low costs etc. The adoption of a hollow shaft permits to use a transmission shafts, or passing axles, in the shorter version of the engine with too or three cylinders, dedicated to the automotive field; it is possible, in fact, to draw the friction and the gear around the differential putting the cylinders at the sides of it that with the passing axles passing through the cavity of the engine shaft. can give the motion directly to the moving tires. If the space is not sufficient or more cylinders are needed, it would be possible to put than the engine and the differential longitudinally lengthwise the car, dividing in this way the couple to the anterior and posterior axles without the need of gears, reducer, shafts, or else.

It is anyhow possible the use of the engine with 2, 3, 4 or 6 cilinders, in a traditional way combining a clutch and a gear box directly to the engine shaft. In the aeronautical applications, this engines even more evident advantages considering the weight and the reduced frontal section but also the very high specific power together with the low consumption.

In the versions with 3 cylinders 1500 cc. The power and the couple obtainable are even greater than the ones of a four stroke with 8 cylinders and a displacement of 4000 cc. it must be underlined that all this is done with the half of r.p.m. And for that there are no needs of gear redactors for the propeller.

A considerable vantage is the possibility easily adopt to counter rotating propellers by putting inside, also in this case, a transmission shaft in the cavity of the engine shaft and inverting with gears on the back the rotation, or, in case gears are not desired, because of the increment of friction, you can make two engine work in the two possible rotating senses. in an independent way, and giving the motion to one of the two propellers directly and to the other with a shaft passing through one of the two engines. There are several possible applications, also in nautical field and on overcraft.

Particularly WIG (Wing In Ground—effect) or ecranoplans, that are considered of immediate diffusion, the necessity to have a high power during the take off, but a far less powerful push during the normal cruising creates the conditions for N.E.V.I.S. to be the only possible choice, considering that the optimal efficiency remains also at partial charges.

But the aspect that must be underlined is that it is reasonable to find out a specific consumption much lower, considering that there are half of the strokes, that there is reduction of friction because of the reduced number of segments, the utilization of the chinetic energy of the exhaust gases that would otherwise be loosed, the exploitation of a bigger expansion, particularly at partial charges, the optimal compression ratio at all rpm and at all charges and that will be more elevated than the optimal compression ratio of traditional engines, tails to the uniformity of the temperature of the head; in eventual automotive applications also the elimination of the gear for the reduction at the transmission and the elimination of the transition itself that originate a considerable absorption of the 30% of the power available for the tires.

There are remarkable advantages from an industrial point of view, and for the low production cost and for the commercial faciitations of a competitive product, but also for the reduced investment needed for the industrialisation itself that are not encumbered by the necessity of sophisticated process or unusual machinery.

### BRIEF DESCRIPTION OF DRAWINGS

The previous and other aims, characteristics and advantages of the invention will bee evident in the further and detailed description of preferred forms of realisation of the invention as illustrated in the enclosed drawings in which the reference mark is referable to the same parts but from different point of view. The drawings are not necessarily in scale 1/1 being principally emphasised the illustration of the principles of the invention. The

FIG. 1 is a lateral show view sectioned of the engine that shows an assembly of a cylinder with an engine shaft that has profiles an annular piston and valve and a controlling system of the phase and of the compression ratio.

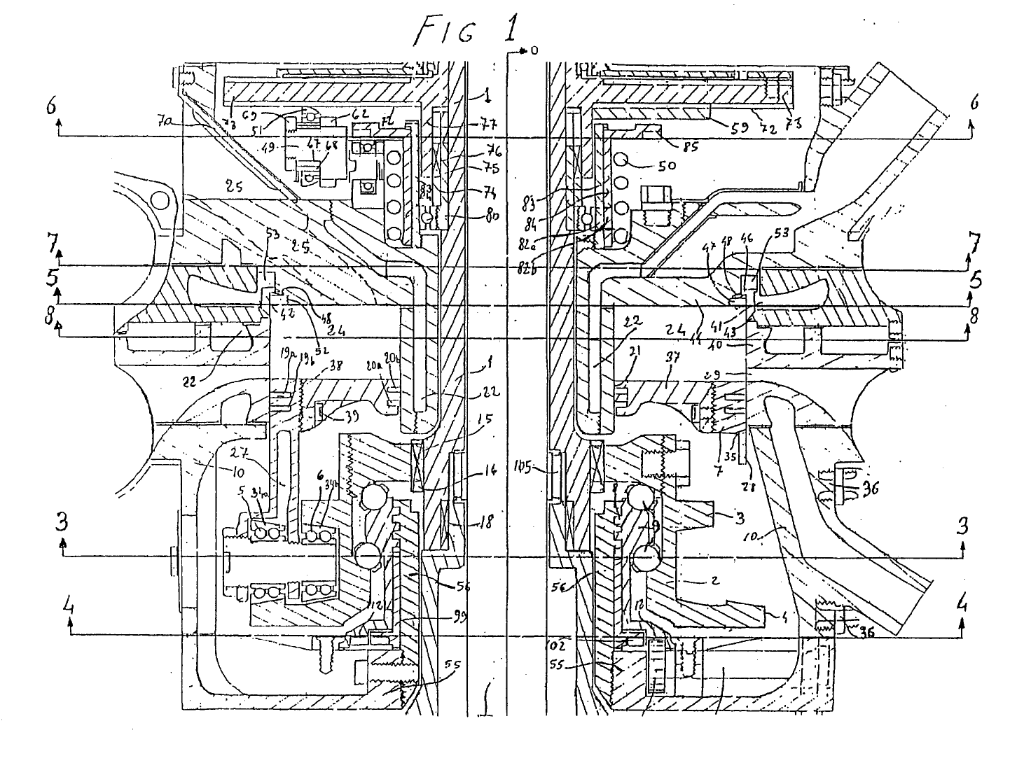

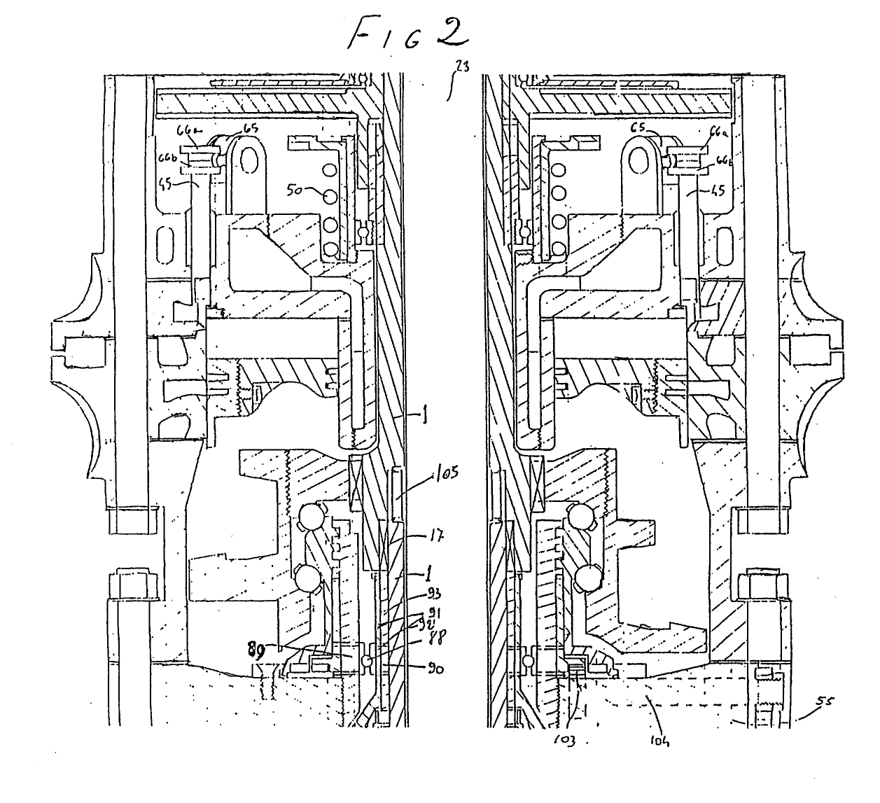

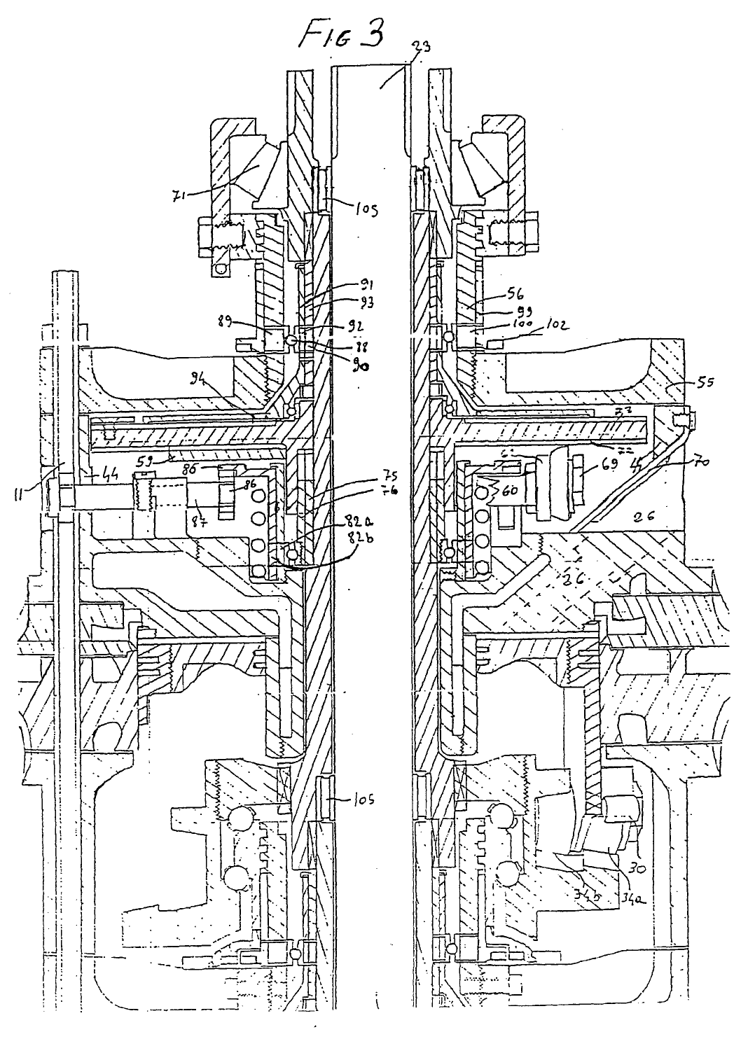

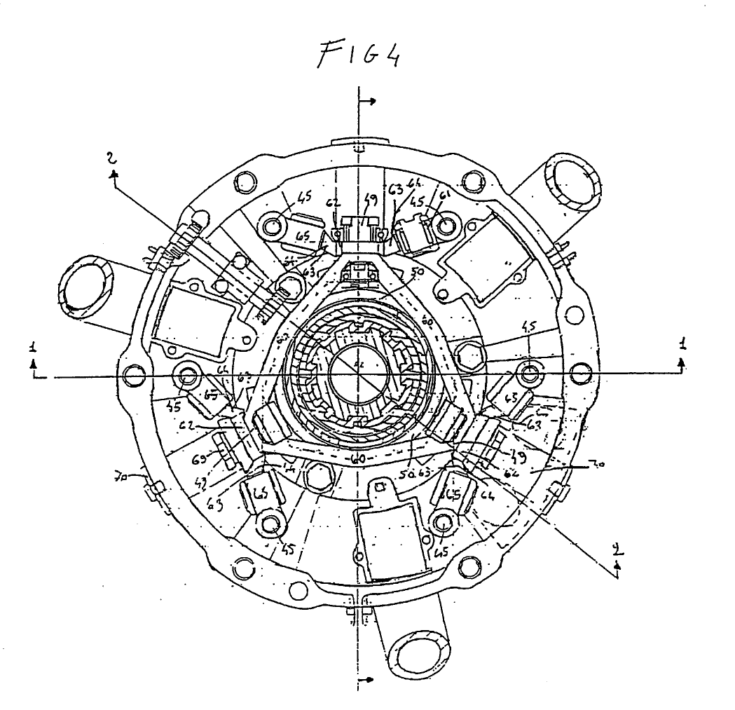

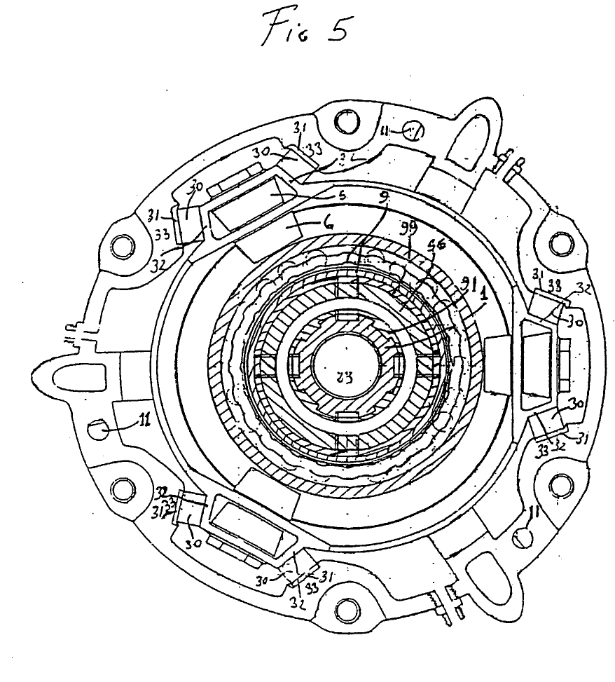

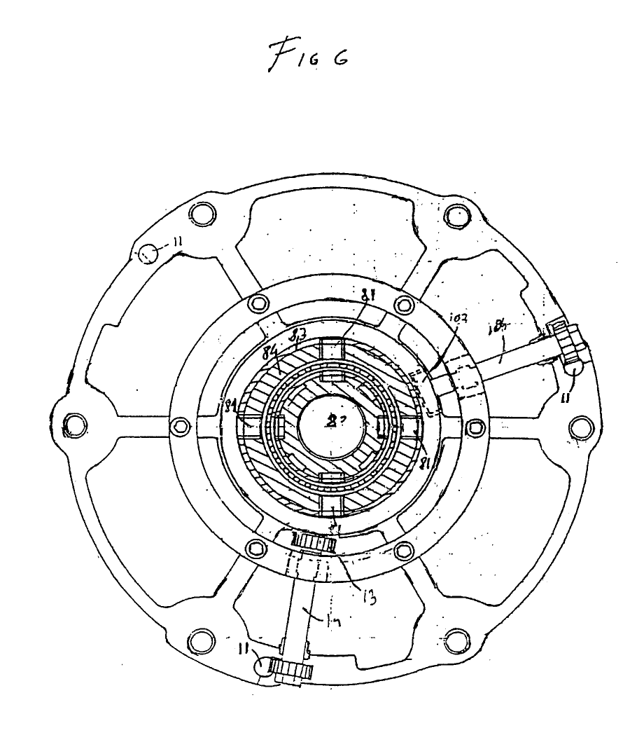

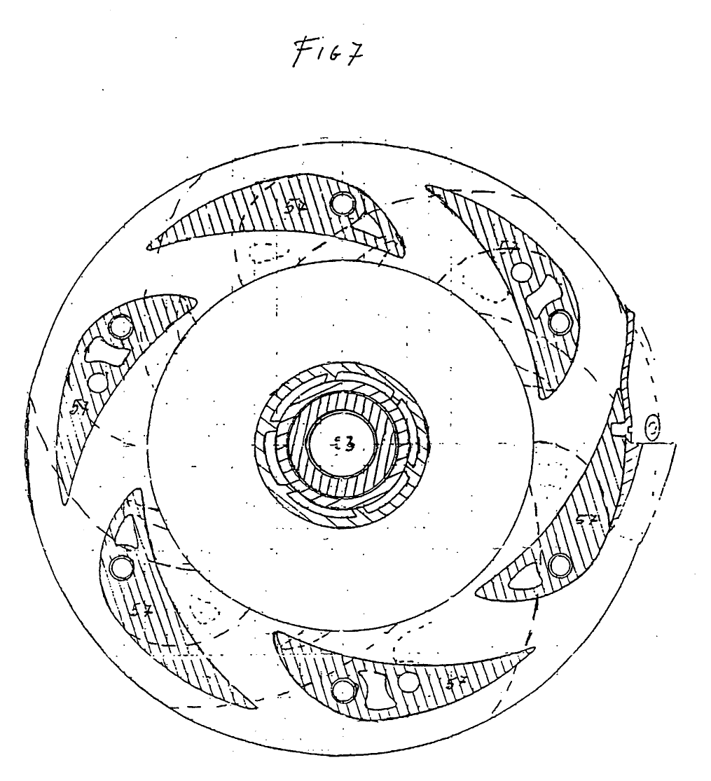

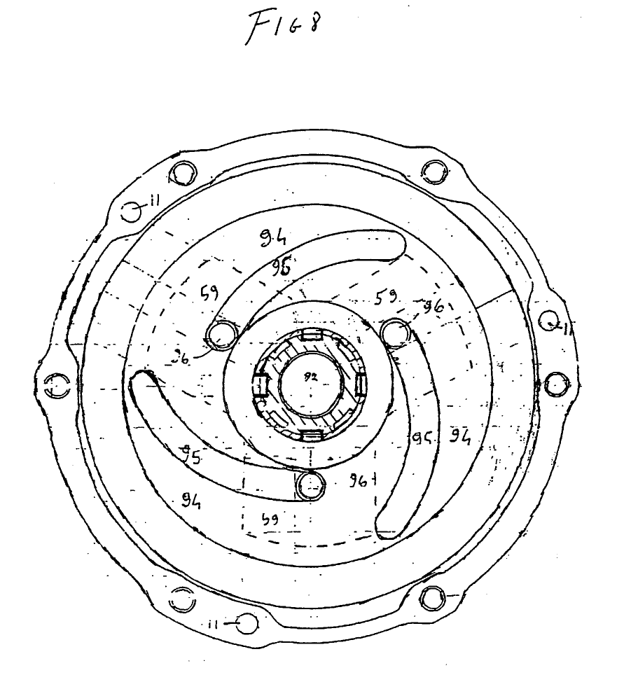

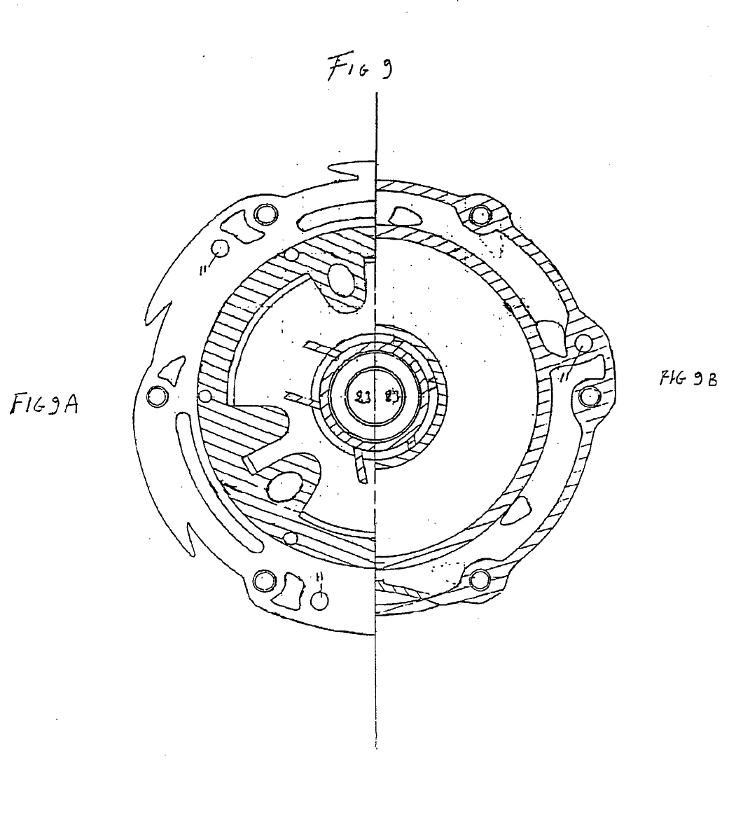

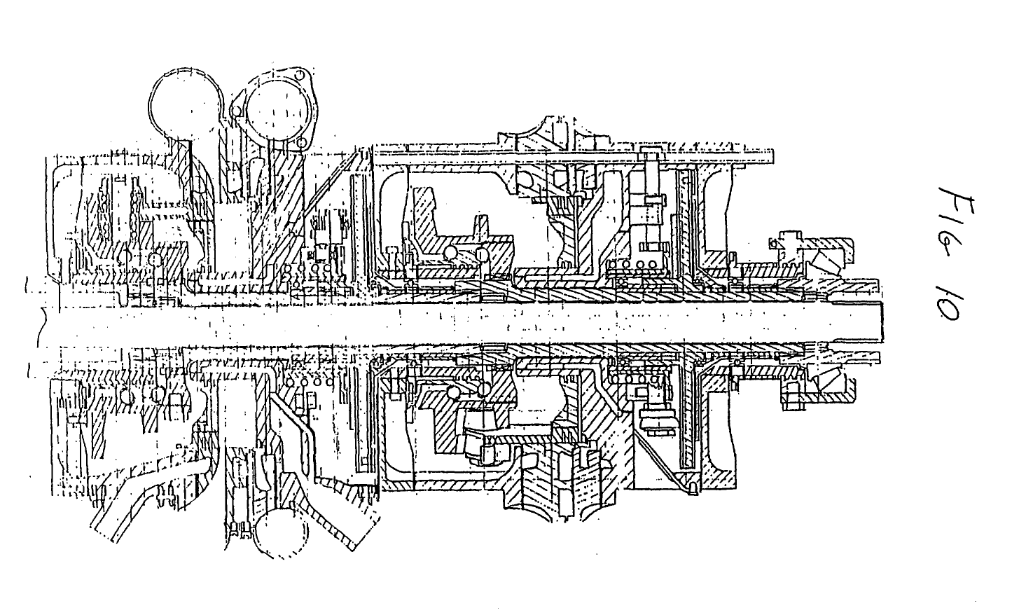

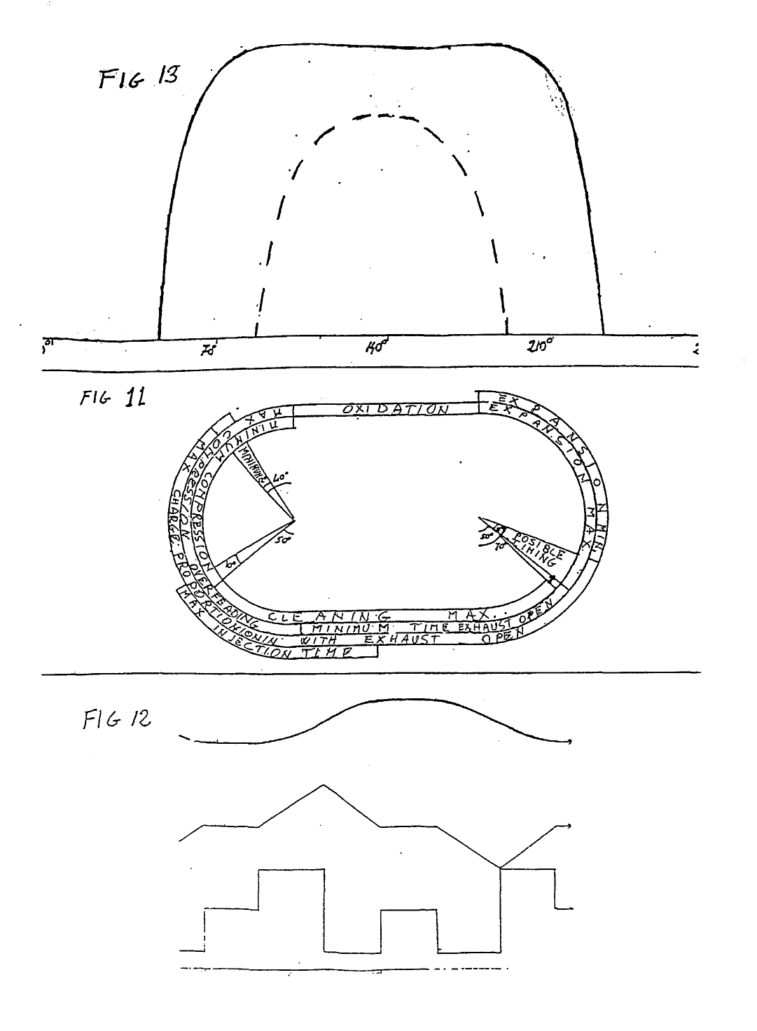

The FIG. 4 is a partial sectioned frontal view of the engine on the line 6-6 of the FIG. 1 and shows the structure was the tappets and the connecting road are settled.

The FIG. 2 is a lateral view sectioned along the line 1-1 of the FIG. 2 that shows the stems and relative connecting roads.

The FIG. 3 is a lateral view of the section along the line 2-2 of the FIG. 4 and shows a tappet and the relative supporting structure not sectioned, together with the ball bearings and the guiding rollers of the annular piston, this also not sectioned

The FIG. 5 is a view partially sectioned along the line 3-3 of FIG. 1 that shows the internal part of the piston and his not sectioned ball bearings.

The FIG. 6 is a partial view along the line 4-4 and show the top part of the superior head top or of the block (that is the same

The FIG. 7. Is a sectioned view along the line 5-5 of FIG. 1 it shows the deflectors that invite the exhaust gas towards the relative duct that is not represented, in transparency, by the way, you can see the deflectors of the intake that is below.

The FIG. 8 is a partially sectioned view along the line 9-9 of FIG. 3 and shows the system for the variation of the charge that is under the cover of the head, considering removed this last one together with the ballbearing that is cut from the section itself.

The FIG. 9 is composed by two semisections, the 9a and the 9b. The FIG. 9a is a view of the section that is along the line 7-7 of the FIG. 1. The FIG. 9b is the view of the section that is along the line 8-8 of FIG. 3.

The FIG. 10 obtained by putting beside one up the other one the FIG. 1 and the FIG. 3, it gives an idea of the proportion of a bicilindric (that is the minimum number of cylinders to avoid balancing problems)

The FIG. 11 represents a possible diagram of the timing system and of the sequence of operatively of the intake, of the partialization of the exhaust, of the injection, of the ossidation, of the washing phase, of the expansion, of the compression of eventual supercharging.

For a correct reading of the diagram, it is necessary to remember that the rectilinear parts of the oval of the graphic represent the standings of the pistons towards the dead points, that to be more clear and to make possible direct comparison with a “four stroke”, the real degrees of the revolution of the engine shaft are 4.5 times so the standstill of the pistons if in reality of this case continue for 20° degrees of revolution. they must be considered equal to the time that a “four stroke” needs to do 90° degrees of revolution, so an entire operative cycle is represented on the graphic in 540° degrees, but the real amount of degrees of the shaft tour is only 120° degrees, with a complete tour of the engine shaft three operative cycle are completed.

The FIG. 12 represents graphically a low of the motion with the relative accelerations and velocities of the piston for about 120° deggrees of tour of the engine shaft.

The FIG. 13 represents graphically the difference between the instantaneous flux coefficient of the classic “two stroke” (dotted line) and the instantaneous flux coefficient of the intake of the engine.

### DETAILED DESCRIPTION OF DRAWINGS

### STRUCTURE OF THE SISTEM FOR THE TRASFORMATION OF THE ALTERNATE MOTION IN ROTATORY MOTION

From now on if not differently specificated we are referring to FIG. 1.

In the illustrated form of realisation has been introduced a support substantially cylindrical (2), that surrounds the engine shaft (1) with hum is coaxial and solid in the rotation. The support (2) is provided of two protrusions or profiles (3-4) that surround it all around with a cyclic undulating course. Between the two protrusions, (3-4) three couples of ballbearings operate (5-6) attached to three supports (27). that are part of a piston (7); the ball bearings (5-6) are bind from the same supports (27) to move only in parallel with the axis (0-0) of the engine (1), that for wen they are pushed from pistons (7) on the undulations of the profiles (3-4), the resulting force, applied at the point in witch the ball bearing (5) are in contact with the protrusion (4), imply the rotation of the support (2) and for this the rotation of the engine shaft (1).

Vice versa, when is the support (2), on the engine shaft (1), to set the motion to the ballbearings (5-6) with his rotations balbearings in their alternative movement, will follow the accelerations and the decelerations caused by the undulations of the profiles (3-4) that are coherent to a curve that has a rectilineous course at the tops in order to permit the standing of the pistons for a certain while at the dead points. The same curve implies to the balbearings (5-6) constant acceleration and deceleration during their alternative motion. Naturally, whether is the engine shaft to drive the pistons motion or otherwise, one of the two profiles (3-4) is used to push, the other one to call back balbearring (5-6), similarly the balberrings (5-6) invert the task one to push and one to decelerate the piston at every stroke.

The profile (3-4) developed on an even surface of the velocity of the piston (7) and the accelerations of itself, are represented graphically in FIG. 12 where. for simplicity. it has been considered only one operative cycle, while in reality the cycles are three for every revolution.

It is possible to easily vary the compression ratio causing a minimum axial movement parallel to the axis (0-0) of the support (2) on the engine shaft. The movement can be regulated in an extremely precise way with a screw (8) that recalls or pushes away the balberring (9) with doubled balls that fixes the support (2) to the cylinder (56) attached to the cover (55) of the block (10) and not to the engine shaft (1). With a geared (12) which is independent from the axial movement of support (2) but connected to circular movement imposed by the internal screw (8) of the ball bearing (9), it is easy to control the amount of turns of the screw to obtain the optimal compression ratio; a small gear, engaged with the gear (12) of the regulator that has his axes (14) extended towards the external part of the block (10), can give the possibility to regulate, with a special device to external actuators. The support (2) with the profiles (3-4) is connected to the engine shaft with an internal groove (15) and with an external groove (16) of the engine shaft. There is no need of counterweights of balancing, if the pistons (7) are two, three, four or six The only vibrations in need to be extinguished, are the torsional ones of the engine shaft (1). A connection with engine shaft via normal elastometers, largely in use, can easily absorb a vast range of frequencies, and, like in traditional engines, the adoption of the vibration redactors it is necessary to avoid the rupture of the shafts for stress.

The shaft one is hollow and has other two grooves (17-18), an anterior and external one (17) FIG. 2 and a posterior and interior one (18) FIG. 1 where a bigger diameter permits the junction with the groove of other shafts of equal engine units that are desired.

Other peculiarities of the shaft (1) are treated in the part that regards the timing system and the part concerning the possible configurations.

### STRUCTURE OF THE PISTON AND OF HIS BALLBEARINGS

The annular piston (7) can appear at first a strange and little self-defeating choice. It doesn't seem in fact to promise reductions of friction the segments (19,20) on the external side (19) plus the internal ones (20) on such a piston (7) (it is well known that the perimeter of a circle is much shorter than both the perimeter of a donate covering the same area of the circle). Even less promising seems to be the increased mass, due to the increments of the diametrical dimensions of the annular piston (7). But as often happens for the things that are not immediately intuitive, it is necessary a deeper analysis to make better judgement.

To begin let's compare to the annular (7) a traditional piston, let's say of 86 mm of bore and with a stroke of 86 mm, for a unitary displacement of 500 cc. A so-called super squared like the more recent applications. The first data says that the surface interested by the friction of segments in the classic piston is 23223,44 mm 0.2, this surface can be considerably reduced, if the diameter of the piston is enlonged, with respect to the stroke (obviously maintaining the same displacement).

To go other a certain limit by using big diameters with traditional pistons is not convenient because of the problems of cooling the centre of the piston, that being far from the cooling liquid is not able to drain all the heat that it accumulates, the thermal efficiency deteriorates because of a bad surface/volume ratio and the time to complete the combustion is longer due to the longer distance that the front of flame has to cover.

For this reasons bores bigger than 80-90 mm. Are rarely used in displacements of 500 cc.

With the annular piston (7) it is instead possible, to have much bigger diameter, standing the possibility to cool down easily the central part of the piston (21).

A surface of the top of the piston (7) around 3.4 times bigger than the piston with 86 mm. Of bore, gives the opportunity to reduce the stroke of the piston to 25 mm.

If the diameter of the internal hole of the annular piston is 80 mm, enough to give place to the cooling water (22), to the engine shaft (1), and to the transmission shaft (23), —the external diameter of the piston has to be 178 mm, if we wont to obtain a volume of 500 cc. Of the combustion chamber (24).

In this way it does not exist a point of the piston that has a distance from the cooling liquid bigger than 24.5 mm, like in a classic small piston of 49 mm. Of bore.

An interesting surprise, continuing to analyse, comes also from the evaluation of the reduced surface that the segments (19,20) involve with their alternate motion witch results 20.253 mm 0.2 against the 23.223 mm 0.2 of the traditional piston, in other words a 15% bigger surface than the annular.

The exploitation of the expansion of gasses is much bigger especially at partial charges, not particularly thanks to the new piston (7) that doesn't anyway cause worsening against this aspects, but thanks to factors that are more clearly disclosed in the chapter structure of the regulation of the charge.

The oxidising process. thanks to a long permanence of the piston to the top dead points, has more time to be completed and in a constant volume, but to have a certain symmetry of the pressures of the expansion, of the front of the flame and for security reasons in the aeronautical applications, it is useful to adopt in the planned space (25), three sparkplug and three injectors in their correct position (26) FIG. 3 (that operate at a relatively low pressure, for the gasoline version), these lastones to prevent also a bad mixture of the fuel in places between them distant in the combustion chamber (24). The adding cost of a sparkplug and of two injectors per each cylinder, are compensated by the fact that a single annular piston (7) realizes in the same time a triple number of operative cycles with respect to a normal piston two stoke. In other words it is like having a piston that does the job of three traditional ones.

The mid velocity of the annular piston (7), thanks to a very short stroke, remains very slow, in fact at 2500 r.p.m, the annular piston goes up and down 7500 times per minute, but the mid velocity of the piston is only 6.25 mt/s, (eliminating from the calculus the standing time of the piston 8.33 m/s) against 21.5 mt/s of the piston with the bore and the stoke of 86 mm., that at 7500 r.p.m. With that stroke involves inertias of the piston that are not comparable to the inertia of the annular (7), that even though is more heavy, it has three different point of sustaining (27) instead of one and takes advantage of a stroke 3.5 times inferior.

Also the constant accelerations implied from the profiles contribute to keep maximum velocities of the piston (7) very low, for an ulterior advantage of the inertia FIG. 12.

It must be considered that the low surface/volume ratio of the combustion chamber (24) it becomes an advantage, considering the necessity to draw out a bigger amount of beat due to the increment of the number of the combustions, anyhow the lower temperature in the most critic point, the centre of the piston, helps to limit the subtraction of heat that on the contrary has necessarily to be very high with normal pistons if you want to cool down the central part of them. It is clear that of this takes advantage the dimensioning of the cooling system but principally makes the engine more adiabatic. The symmetric and uniformly distributed temperature, at the end, helps to prevent near by the intake holes, undesirable deformations of the cylinder (28) which are typical in classic “two stroke”.

By the side there are many examples of “two stroke” engine with driven exhaust valve that under this aspect are durable and secure. If the ballbearings were one ap on the other, like on existing engines that have the cylinders axis parallel to the rotating axis of their shaft, the support (27) dimension, would be double, this would be a disadvantage, not only for the masses in alternate motion, but also for the deepness and dimensions of the block (10) that is supposed to be added together with other similar blocks (10) and that for must be quite compact.

The ballbearings (5-6) that are of double bols type, that for of a certain cost, must be necessarily chosen to obtain a correct and secure functioning and allows very hi performances.

The adoption of the ballbearrings is also to be referred to the chosen kind of lubrication for the engine, that happens thanks to controlled spry, which is better than the traditional because it has less absorbing power, it make possible to eliminate one segment that should be at the short base of the piston (28) which base is able to avoid oil transfers in the duct of the intake (29), nebulization, system also permits to eliminate periodical substitution of oil, it is possible to eliminate the oil cup that would ruin part of the advantages of this compact engine that, has besides a very low barycentre and the modularity of the engine would necessitate of a plurality of oil cups still worst a plurality of oil pumps.

The ballbearing (5-6), on the other hand, do not suffer for the problem of absence of lubrication during the startings. At the end the ball bearing (5-6) are subjected to the same consideration expressed for the sparkplug and for the injectors, one annular is like three traditional pistons.

The function of the wall of the piston (28) (the internal part (21) is not provided of a wall) is to be considered of structural strengthens for the annular piston (7) and as a limitation for the oil that is not supposed to enter in the intake, and not as a surface useful to contain the lateral pressures caused by the traditional connecting rod that here are eliminated together with all problems of balancing and of weight.

The annular piston (7) is subjected to forces and couples that cause only rotations on his axis when the profiles (3-4) imply the ball bearings (5-6) to move.

To solve it is sufficient to put 6 rollers (30) FIGS. 3-5 that have undulated surfaces between opportune guides (31-32) FIG. 5, with equally undulated surfaces and fixed to the sides of the support (27) of the ballbearings (5-6) and on the walls (33) FIG. 5 of the block properly contrasting.

Said rollers (30) FIG. 5, of minimum mass and dimension, force the piston (7) to remain in his axial position and preclude the rotation.

The undulated surface of the rollers (30) FIGS. 3-5, combining with the undulated surfaces of the relative guides (31-32) FIG. 5, will oblige the rollers (30) FIG. 5 to remain always in their working position, rotating only of that half tour that the stroke of the piston (7) alternatively imposes.

The rotation axes of rollers though is not parallel to the rotation axes of the ballberring (5-6) of the support (27) of the piston (7), in fact being necessary to incline the external surface (34a-34b) FIG. 3 of the ballberrings (5-6) that are in contact with the profiles (3-4), of about 20° degrees to avoid the wear of the profile (3-4) and of the ball berring (5-6) itself, there are tendencies of the support (27) of the piston (7), although of small entity, to flex toward the external part of the profiles (3-4).

So to avoid this tendency, also the rollers (30) FIG. 5 and the guides (31-32) FIG. 5 we have a position so that the rotation axes of the rollers (30) FIG. 5 is of about 20° degrees inclined together with the external parts of the support (27) of the piston (7) with respect to the ball bering axes, in a may that the support is contrasted and a rigid imposition of the motion is guaranteed to the piston (7).

While the external segments (19a-19b) of the pistons are traditional, the two internal elastic rings of the pistons (20a-20b) they should obviously tend to contract towards the inside, their hardened face also is internal and they necessitate an accurate definition and experimentation.

It is not necessary to use segments for the oil recall thanks to the kind of lubrication system select, certain holes (35) in the wall (28) provide to drown the oil towards the lowest part of the bock (10) where different holes (36) provided to suck that modest quantity of oil exceeding. thanks to the depression created by two normal external oil pump that have to be selected considering the number of modular engine units desired, the same is for the water pump, for the injector pump, for the gasoline pump or for the gasohol pump.

It is planned, that the piston (7) can interchange the surface of his top (37), and this to have the possibility to choose either the functioning with the spark ignition either the functioning with the ignition caused by compression, that is in need of a thicker top of the piston (37) and foresees under the injectors (this interchangeable to) the cavity useful for a correct combustion.

An internal screw (38), close to the external segments (19a-19b) enables a secure and easy assembling of the to possible tops (37), the blocking is ensured by two nozzles (39) that contrasting on the screw (38) prevents the unscrewing.

While the interchangeable internal part (37) of the piston can be of aluminium, for the external part (7) materials like the steel are more indicated and have the double advantage of a reduced dilatation and of a hardened cavity for the segments (19a-19b) that are often subjected to wear if they are of aluminium, more the strengthens needed for the support (27) of the ball bearings (5-6) couldn't be easily reached with the aluminiun.

### STRUCTURE OF THE INTAKE

One of the most serious limitations of the normal two strokes is due to the dimensions of the holes of the intake and of the exhaust that have a very modest space on the cylinder walls. In this engine it is possible to have a very vast total surface of the intake holes (29)—positioned in the lower part of the cylinder (40)—, this because the exhaust (41) is in the hi part of the cylinder (40) that is obviously annular. To this must be added the fact that the piston (7) stops at the inferior dead point holding in an open position the intake holes (29) for a pretty long time. Consider the instantaneous flux coefficient compared with the fluxage of the classic “two stroke”. FIG. 13

The adoption of ducht with variable geometry could enlarge considerably the range of r.p.m. In which is possible the use of the aspired versions of this engine, this factor results more clearly in the chapter STRUCTURE OF THE REGULATION OF THE CHARGE.

### STRUCTURE OF THE EXHAUST

The system to effectuate the exhaust is driven, it has an ample surface (41) for the outflow of gasses, coherently to the intake (29) and is developed all around the top part of the cylinder (40), the part that is not tacked by the segments (19a-19b) in their alternate up and downs, it is an annular fissure few millimetres high, in this case around 4-3 mm, the valve (42) to close is that for annular and it lifts and it shuts down like a guillotine (43) from the point of contact with the cylinder (40) toward the head of the engine (44) and viceversa

Similarly to the annular piston (7) it is les solicited by the forces of inertia of a lift that is les than the half f the traditional valve lift. It is compensated in this way his bigger mass due to the grown diametrical dimensions, by the side the forces are shared to 6 stems (45) FIGS. 2-4 symmetrically distant in order to avoid undesired flexions of the ring (42).

Particular attention has to be paid for what follows, the siling of the annular valve (42), has to be ensured on the top, with an edge (46) of the valve (42) that is turned towards the inside of the ring (42) and that lies on another edge (47) created in the head (44) of the engine, where a thin annular spring (48) ensures the desired ermetization thanks to her form and to her elasticity. For the realisation of this spring (48), it will be necessary to choose a material that can keep his elastic properties at hi temperatures to, because if it is true that is protected inside the edge of the head, it is possible to have some blow by of gasses that can reach it

The shape of the spring (48) must guaranty to the valve a variable and ermetic closure at different possible points, considering that is not possible to have a perfect matching of the head (44) with the block (10) and considering that the valve (42) are together with the head (44), if the coupling is not more than perfect, or if you have a lift of the valve (42) from the superior edge (47), it is possible to have leaks, on the other side, if the head (44) is a bit to hi from the block (10), you would have leaks from the low part of the valve (42) that is not able to close all the fessure, because she already tacked the superior edge (47) of the head.

With the thin spring (48) before mentioned these problems are avoided, considering that the amplitude of the flexion of the spring will be higher than the amplitude of the tolerance of coupling of the head (44) with the block (10). Anyhow it is a matter of small flections required to the spring (48) that has to support a relative mechanical strain, so it can be realized with a small and thin band dimension that together with the ample diameter will not have needs of elevated pressure to obtain the vertical deformation desired. The inferior part of the valve (42) does not create particular problems for the sealing, has it can be considered like a valve with a very big diameter, it will be easy so to create a traditional coupling with the point of contact between the valve and the inferior part of the exhaust duct (43), with an inclination of the edge of the contact of 30°-45° of angolation with respect to the axes of the valve. The closure with a certain pressure of the valve will be ensured from a traditional spring (50) considerately large and with a reduced number of spires, calibrated to give sufficient pressure for the scaling in the resting condition and sufficient pressure to bring down the valve (42) after the lift avoiding the detachment of the tappet (51) from the cammes (59) later descripted.

The contact surface between the valve (42) and the inferior part of the duct of the exhaust (43) will be naturally protected with the same material of the traditional seats of valves. In the same way the superior laying point (46) of the valve (42) on the spring (48) will be protected. The laying point or edge (47) of the spring is unscrewable, thanks to the screw (52), from the head (44) to make possible the disassembling of the valve (42).

The common exhaust valves have a serious handicap, they have to be open towards the inside of the cylinder, that for they go against the normal flux of the exhaust gasses that after having surpassed the valves they burn the stems also.

The temperatures that can be reached are very high in comparison with those of the intake valve.

That for it is necessary to use more resistant materials (still with chromium silicium, still austenic with high tenor of nickel chromium), and often tou are obliged to complex realisation, like valve with cavity fulfilled of metallic sodium or lithium potassium salts that transmit better the temperature from the head to the stem of the valve. All these problems do not afflict the new system for the outflow of the exhaust gases; in fact, during almost all the time of the expulsion of the exhaust, the guillotine valve (42) is well protected in his sit (53) right up on the fessure of the exhaust (41), that for it is not exposed to exhaust gases and it does not create obstacles to the normal outflow of them.

The eventual small quantity of heat that would be absorbed when is closed, will be easily drewed through the stems (45) FIG. 2 and through the inferior edge (43) that is close to the cooling liquid (22), like the piston (7). Six radial deflectors (57) FIG. 7 provide to invite gently curving the exhaust gases toward the annular duct that collects the exhaust and that here is not represented, in order to utilize, more as possible, the kinetic energy of the exhaust.

The opening timing can happen in a minimum of 34° of angle of revolution of the engine shaft (1) or maximum 50° of angle (in a “four stroke” this would be equivalent to a minimum of 145° and to a maximum of 305°).

### STRUCTURE OF THE TIMING SYSTEM

Up on three ball bearings (51) it is imposed the lifting law of the exhaust (42) by special cammes (59). Each ball bering is pivoted to the angular limbs (49) of a structure (60) FIG. 4 that has three bars united in order to form a sort of triangle that lies with the sides on a unique recalling spring (50) FIG. 4, the same axle (49) FIG. 4 of each ball bearing has place for a ring (62) FIG. 4 that is free to rotate around his axis and is provided of two protuberances (63) FIG. 4 symmetrically displaced on the external part of the ring, where are hanged the extensions of two distinguished oscillating supports (65) FIGS. 2-4 that work on roller bearings (61) FIG. 4, this extensions are very short because the oscillating supports are very close to the relative operating stems (45) FIGS. 2-4 to be lifted and that are provided of special regulating tappets (66a, 66b) FIG. 2 that are screwed on the stem (45) FIG. 2 and permit to be regulated and fixed. The necessity to have this ring (62) FIG. 4, free to rotate on his axis, is caused by the difficulty to have a constant and identical regulation of the tappets (66) FIG. 2 of two stems (45) FIG. 2 that are close. With this system if a tappet loses his regulation (in force of the expansion of the stem for instance), the ring (62) FIG. 4 is able to compensate automatically the difference of the laying tolerance between the two tappets (66) FIG. 2 always lifting them in die same time and in the same way.

If two tappets (66) FIG. 2 are lifted at the same time from the ring (62) FIG. 4, than only three rings are necessary to lift all the stems; as a mater of fact there are three rings (66) FIG. 2 coupled with three regulating ball bearings (51) that work as the real roller tappets and obtain a contemporaneous contact between all the ball bearings (51) and all the cammes (59). This regulation is made possible by the adoption between the axle (49) and the ball bearings (51) of two concentric and eccentric rings (67-68); that can be caunterotated of few degrees in the opposite senses causing a precise shifting up or dawn of the the rollertappets on their axle (49), than they are blocked by a small nut (69) screwed on the axle (49). This regulation can be done with out opening the engine thanks to proper small windows (70) that give easy access.

The choice to adopt the oscillating supports (65) is necessary if you want to eliminate the vibrations caused by the alternate motion of the valve, it resulted necessary to reject the idraulic tappets, because they can't reach hi r.p.m. and complicate considerably the general structure, being also expensive.

The stem (45) are very short and being united but not welded with a quite could valve (42) they shouldn't be subjected to appreciable enlongements, when the engine rise the operating temperature, any haw their enlongement can be compensated with a regulation of the conic roller bearing (71) FIG. 3 used to hold the engine shaft (1) FIG. 3, at the end of the last engine unit, the lengthening of the stems in any case, do not cause an approaching of the roller tappets (51) to the cammes (59), but a gap; that for the regulation of the roller tappets has to be done by putting in contact the roller tappets (51) with the surface (72) of the overhanging disc or flat support (73), obviously in the point where it's flat and not where there are the cammes (59), that are the eccentrics of a normal camshaft developed on the plane. This cammes (59) are free to move to the external part (73) FIGS. 1 and 8 of the support or viceversa; the support (73) is engaged with the engine shaft (1) and has an ample diameter so to permit to the three cammes (59) sufficiently extended movements.

The cammes (59), opportunely moulded, press contemporaneously on all the roller tappets and the laws of the lifts vary, principally their duration, depending the positions of the cammes imposed is more or less periferic on their support (73), while the beginning of the lifting phase can vary thanks to a system that is able to modify the angular position of the support (73) of the cammes in comparison with the coaxial engine shaft as much as needed.

This variable timing system is made of a cylinder (74) provided of a groove (75) in his internal part while the external part has an elicoidal groove (76), the cylinder (74) is placed in between the central part (77) of the support (73) of the cammes and the engine shaft (1) that are coupled via their respective grooves (78-79) to the cylinder (74); to effectuate the variation of the timing, the cylinder (74) is moved up or down of few millimetres, by a ball bearing (80) welded on him and that aghen is moved up and down thanks to the adoption on his external part of 4 small pivots (81) FIG. 6 that are inserted in symmetric oblique guiding fissures (82) FIGS. 1 and 4 on the curved face of two external cylinders (83-84) concentric between them and the ball bearing (80), one of this cylinders (83) is fixed to die block (10). wile the external can be to rotate on his axis. in this way changes the angular position of his oblique fissures (82) FIGS. 1 and 4 that are oblique in the opposite sense of the ones on the internal cylinder (83), so the contrasting push of the edges of two guiding fissures, internal and external applied on each pivot causes a lift or a lowering of all the pivots and of the attached ball bearing (80).Tie external cylinder (84) is provided than on tile top part, of a gear (85) engaged with a smaller gear (86) FIG. 3 that has an axle (87) FIG. 3 that transmits the rotation to the external part of the block (10) permitting the regulation of the timing system with extending devices to computerized actuators.

### SISTEM AND STRUCTURE OF THE REGULATION OF THE CHARGE

The principal innovation of this engine is the system used to vary the needs of charge.

The extended opening of the exhaust valve (42) give to the piston (7) the possibility to expel the air that replaced tile exhaust gasses with the cleaning phase, the longer is the time the valve (42) stays open the smaller is the amount of air that remains for the successive operating combustion and being possible to vary the compression ratio, it is possible to have really small quantities of air charge. In other words we reduce the charge but not the efficiency of the engine that utilise entirely the expansion of the combustion with an expansion stroke that results very long in relation to the small charge.

Viceversa if the opening time of the exhaust valve (41) is short and the air entered is not allowed to get out from the exhaust duct (41), the compression ratio can turn back to the initial proportion, that for, remarkable charges can be reached, specially if the inertia of the air in the intake duct originates some overfiding. It is better though, to be coherent with the attention paid to efficiency until now, not to feed with to hi pressures the engine, because this needs higher depressions in the combustion chamber that can be obtained only using the kinetic energy of tile exhaust gasses that. getting out with hi velocity, cause depressions as intense and durable as long lasting and consistent is the outflow of the exhaust, so anticipating the opening of the exhaust valve when is still present a certain pressure in the combustion chamber improves the fulfilling, but causes a loos of efficiency because it is not used entirely the pressure created by the expansion of the combusted gasses.

In those cases in which turbine compressors are adopted, or passing from the gasoline version to the diesel version, it will be possible to reduce or increase the compression ratio as needed, by programming again the hardware that assist the actuators of the timing and of the variable compression ratio system, so to make possible to regulate the needs of charge in an optimal progression, with the various possible opening laws of the exhaust

But let's see haw do the cammes (59) FIG. 3 move on their support (73) FIG. 3 to effectuate the acceleration: also in this case like in the in the system for variating the thiming, a ball bearing (88) FIG. 3 with four pivots (89) FIG. 3 summetrically welded on the external part and four pivots (90) FIG. 3, symmetrically welded inside, can move up and down coaxial and in parallel with the engine shaft (1) of about 4 cm, the internal pivots (90) FIG. 3 are inserted in oblique guiding fessure (92) FIG. 3 of a cave cylinder (91) FIG. 3 that is internal and concentric to the ball bearing (88) FIG. 3, the four pivots (90) FIG. 3 trapassing the fessures are inserted then in the groove of the engine shaft (1), while the pivots move up or down together with the ball bearing (88) FIG. 3, they contrast the oblique fessure (92) FIG. 3 and cause a rotation of the cave cylinder (90) FIG. 3 of 90°. On the lower part of this same cylinder (91) FIG. 3., a part provided of oblique fissures (95) FIGS. 3 and 8 that guide the pivots (96) FIG. 8 that are fixed this time on the opposite face of the mobile cams (59) FIG. 2 that are driven by the rail (97) FIG. 8 of their support (73) FIG. 8. The pivots (96) FIG. 3 are pushed from the guiding fissure (95) FIG. 3 towards the outside or the inside of the support (94) FIG. 8 with the cams (59) FIG. 2, without having centrifugal complications, because the guiding fissures (95) FIG. 8, degrade towards the centre of the disc (94) FIGS. 3 and 8, fixed under the cylinder (91) FIG. 3 before mentioned, with an acute angle and like a spiral.

The external pivots (89) FIG. 2 of the ball bearing (88) FIG. 3 differently, are inserted in other two concentric cylinders (56-99) FIG. 2 these two also provided of fissures (100) FIG. 3, one cylinder is fixed to the cover (55) FIG. 2 of the head (44) FIG. 3 the other one is rotating and provided of a gear that when is rotated via another small gear engaged with it and provided of an extended axle toward the eternal part of the cover (55) FIG. 2, happens to obtain the movement up or dawn of the ball bearing (88) FIG. 2, that causes as said the rotation of the disc (94) FIG. 3 and 8 that moves the pivots of the cams forward or backward.

### DIAGRAM OF THE TIMING SYSTEM

The diagram of the timing system of the engine see FIG. (11) represents one of the possible diagrams of the timing of the operative timing phase of the admission, of the overfeeding, of the charge proportioning, of the injection, of the compression, of the combustion, of the expansion of the expulsion of exhaust, of the cleaning. For a correct reading of the diagram, it must be remembered that the rectilinear parts of the oval in the graphic, represent the standings of the piston to the top dead point and to the low dead point, to be more clear and to make possible a direct comparison with the “four stroke” the real degrees of the rotation of N.E.V.I.S. shaft have been expanded 4,5 times, that for also the standings of the pistons that happens during an angle of the shaft revolution of 20° degrees, is represented in the graphic expanded in 90°, so an entire cycle happens on the graphic in 540°, while in reality the degrees of the angle of the shaft rotation are 120°, that means that with one complete rotation of the shaft three operative cycles are executed.

The combustion chamber (24) of 178 mm of bore, the three sparkplugs are symmetrically positioned at a distance so that the farer point that has to be reached from the front-flames ,is of 77.5 mm, that is not a lot but not so little considering that is the 45% more in comparison with the traditional combustion chamber of 86 mm of bore with the sparkplug positioned in the centre, anyhow this difference assumes relative importance considering that ,thanks to the standings of the piston, the front of the flame has almost triple time to cover the 77.5 mm of distance (comparing with the “four stroke” the duration of the spark advance is like having 150° instead of 60° of angle of rotation of the “four stroke” engine shaft).

While the invention has been particularly disclosed and decripted, referring his best and preferred forms of realizations, it will be understood from technicians and experts that various modifications of form and of details can be realized without leaving the spirit and the aim of the invention

1) a method in an alternative, internal combustion engine, inclusive of an operative cycle that foresees at least one admission phase, one proportioning phase, one combustion phase and provided of a combustion chamber, an intake system, a system and a duct for the expulsion of fluid from said chamber, a timing system to control the opening and the closure of the system of fluid expulsion; characterized by the method used to effectuate the proportioning phase that regulates the fluid quantity to be used for the combustion in the chamber at every operating cycle and that happens expelling part of unburned gases, cyclically entering in the chamber during the admission phase, from the exhaust duct and with the expulsion system, before the combustion phase.

2) A method for an operative cycle in an alternative internal combustion engine, inclusive of eight possible phases: expansion, exhaust expulsion, cleaning, comburent admission, proportioning, fuel injection, compression, combustion; provided then of one ore a plurality of combustion chambers with relative included pistons free to slide in accordance with a sliding axis in the limits of a stroke imposed by a system for the transformation of the alternate motion in to rotating motion. Characterized by the fact that a complete cycle of all the phases happens during the time of two stroke Plus the time of two stasis of the piston in proximity of the superior and inferior ends of the strokes, in accordance with the following operative timing:
First stroke—expansion-exhaust expulsion-beginning of cleaning.
First stasis(at the point of inferior ending stroke)—ending of cleaning-admission comburent.
Second stroke—ending admission comburent-eventual proportioning-fuel injection-compression.
Second stasis(at the point of superior ending stroke)—combustion.

3) An alternative internal combustion engine, provided of one, or a plurality of combustion chambers with relative enclosed pistons free to slide in accordance with a sliding axis, endowed of supports and ball bearings or roll bearings, of a system for the transformation of the alternate motion in rotating motion, this system being characterized by an axle (1) (or engine shaft), around which there is a support (2) united in the rotation with the engine shaft; this support (2), is surrounded by a slot or guide that is coherent to an indefinite conic or cylindrical surface which axis is the same of the support rotating axis, the advancing progress of the slot around this indefinite conic or cylindrical surface is cyclically rectilinear and/or curved. In revolving contact with the opposite internal faces (3-4) of the slot or guide, operate some ball bearing (5-6), hush pivots together with their supports and the relative pistons, are bonded to move only in accordance with the sliding axis of the pistons in their combustion chambers.

4) An alternative internal combustion engine adopting a block that includes one or a plurality of combustion chambers with relative enclosed pistons free to slide in accordance with a sliding axis, the pistons are provided of supports and of ball bearings pivoted to the same supports. The engine is also provided of an axle (1) (or engine shaft) parallel to the sliding axis of the pistons and of that system that can regulate the volumes delimited by the pistons and the combustion chamber. The system is characterized by a variator (9) substantially cylindrical, screwed internally, coaxial to the engine shaft and screwed to a structure (56) fixed to the cover (55) of the block; around the variator (9), is fixed, coaxially, one or a plurality of ball bearings, or it is created a track for a ring (9) of rollers or balls (9) that are useful to permit the rotation of a larger support (2)that remains anyhow bonded to the ball bearings or to the rings of rollers or ball(9) that follow the variator (9) in his parallel movements to the rotation axis on the screw (8). The large support (2) is coupled with the engine shaft with a groove (15-16) that give him the chance to rotate with the engine shaft (1) and to move according the rotating axis of both (the shaft and the support). The large support (2) is surrounded externally by a slot or guide that sustains the ball bearings (5-6) of the supports (27) of the pistons bonded to move according the sliding axis of the pistons in their combustion chambers.

5) An engine according to one of previous claims, characterized by the adoption of a cave shaft (1).

6) An engine according to one of previous claims, characterized by an annular or toroidal combustion chamber (24) and an annular or toroidal piston (7) defined in said chamber.

7) An engine according to one of previous claims, including a piston and one or a plurality of relative supports (27) each one of said supports provided of one or a plurality of ball bearings pivoted to the sides of the supports (27) of the pistons.

8) An engine according to one of previous claims, including a transmission shaft (1) and a timing system to open and close valves, a regulating system for the beginning of the opened phase of valves; characterized by a regulator (75), substantially cylindrical, coaxial to the transmission shaft (1) and coupled to said shaft with a straight or helicoidally groove, it is possible the parallel movement according to the rotating axle of the transmission shaft (1), of said regulator (75), so to cause a rotation on the transmission shaft (1) of a coaxial external support (73-77), that is bonded in the axial movement, but comprehends the regulator (75) and it is with him coupled via a straight or helicoidally groove, this support (73-77) is provided of cams (59) developed on a plane (72) substantially perpendicular to the rotation axis of the support (73-77) and of the transmission shaft (1), the cams (59) are placed opportunely so that putting in rotation the transmission shaft (1) and with him the regulator (75) and the support (73-77) of the cams, said cams activate with the cyclic contact the roller tappets, the oscillating supports or what ever else can be used to execute the lift of the relative valves.

9) An engine according to one of the previous claims, including tappets, and a timing system to open and close the valves that can modify the duration and/or the highness and/or the accelerations and or the decelerations of the lift of the valves, characterized by opportunely shaped cams (59), positioned on the plane (72) substantially perpendicular to the rotation axis of a rotating support (73-77). This cams, at every revolution of the rotating support (73-77), press subjected push rood, oscillating supports (65), tappets or any other device useful to execute the lift of the relative valves and since the cams (59) can be moved towards or backwards the rotating axle of the support (73-77), their contact point with the tappets (51), or oscillating support (65), or what ever else to execute the lift of the relative valves, can change; in this way tie shape of the cams, on the line contact that pertains the tappets (51), can vary the lifting law of the valves, that change opportunely at every radial movement of the cams on their support (73-77).

10) An engine according to claim 9, caracterized by a flat routable support (94) proximally positioned to the support (73-77) with the cams (59),but facing the back side of the cams (59), both the supports are coaxial ,the flat support (94) is provided of fissures (95) that are spirally extended from the periphery to the rotating axis, although not in a radial way; the fissures (95) are shaped in order to permit to the pivots (96) that are fixed to the backs of the cams (59), to be inserted in. The pivots (96) are also bonded to move in a radial way on the support (73-77) by their slit, so they can be pushed from the periphery of the support873-77) to his central rotating axle and voiceovers, thanks to the pressures caused from the sides of the fissures (95) when their flat support is rotated of few degrees angle with respect to the support (73-77) of the cams. This happens via the possible axial movement of a variator (93) that is substantially cylindrical and that is internally coupled with the transmission shaft (1) in force of a straight or elicoidaly groove, wile externally is coaxial coupled to the routable flat support (94) via similar elicoidal or straight grooves.
11) An engine according to one of the previous claims, including a combustion chamber and an expulsion system, characterised by the fact that an annular valve (42) is used to open or to close an exhaust duct (41) in communication with said combustion chamber.
